(19) United States
(12) Patent Application Publication
(10) Pub. No.: US 2003/0110158 A1
(43) Pub. Date: Jun. 12, 2003

(54) Search engine visibility system

(76) Inventor: Michael P. Seals, Dallas, TX (US)

Correspondence Address: CARSTENS YEE & CAHOON, LLP, P O BOX 802334, DALLAS, TX, 75380

(21) Appl. No.: 10/293,720

(22) Filed: Nov. 13, 2002

Related U.S. Application Data
(60) Provisional application No. 60/337,880, filed on Nov. 13, 2001.

(51) Int. Cl. G06F 7/00

(52) U.S. Cl. 707/1

(57) ABSTRACT

A system and method for making content visible to search engine indexing functions. Among the several embodiments, the current innovations include making database content visible by systematically and automatically creating static web pages from database content that would normally only exist as virtual pages. In another embodiment, content is mapped to a master category list which itself is mapped to multiple search engine directories. By virtue of mapping content to the master list, such content is automatically mapped to the various search engine directories to which the master list is mapped. In another embodiment, keywords and page descriptions are categorized and put into a hierarchy where keywords and descriptions can be inherited between different categories according to a logical structure.

### 1. RELATED APPLICATIONS

At least some of the innovative concepts in this application claim priority from U.S. Provisional Application No. 60/337,880, filed Nov. 13, 2001.

### BACKGROUND OF THE INVENTION

1. Technical Field

The present invention relates generally to web sites, and more particularly to indexing of web sites in search engine directories.

2. Description of Related Art

Search Engines

Crawler-based search engines have three major elements. First is the indexing function, also called a spider, also called the crawler. The spider visits a web page, reads it, and then follows links to other pages within the site. This is what it means when someone refers to a site being “spidered” or “crawled.” The spider returns to the site on a regular basis, such as every month or two, to look for changes.

Everything the spider finds goes into the second part of the search engine, the index. The index, sometimes called the catalog, is like a giant book containing a copy of every web page that the spider finds. If a web page changes, then this book is updated with new information. Sometimes it can take a while for new pages or changes that the spider finds to be added to the index. Thus, a web page may have been “spidered” but not yet “indexed.” Until it is indexed—added to the index—it is not available to those searching with the search engine.

Search engine software is the third part of a search engine. This is the program that sifts through the millions of pages recorded in the index to find matches to a search and rank them in order of what it believes is most relevant.

One of the the main rules in a ranking algorithm involves the location and frequency of keywords on a web page. Call it the location/frequency method, for short.

Search engines will also check to see if the search keywords appear near the top of a web page, such as in the headline or in the first few paragraphs of text. They assume that any page relevant to the topic will mention those words right from the beginning.

Frequency is the other major factor in how search engines determine relevancy. A search engine will analyze how often keywords appear in relation to other words in a web page. Those with a higher frequency are often deemed more relevant than other web pages.

Database Visibility

Search engine indexing functions do not normally index content to databases, because such content is not normally retained in the form of static html documents or other documents. Instead, algorithms are used to generate dynamic or virtual web pages at the time a user attempts to access the page by, for example, linking to the page. However, crawlers normally do not follow links to such virtual pages, and hence database content is not normally indexed. To counter this problem, doorway pages have been used in the art.

Doorway pages can be disadvantageous in that they must be constructed for each individual virtual page to be indexed. This is time consuming and removes much of the advantage to having a database.

Another practice is to pay search engines to accept hidden URLs via an XML feed, for example, Called “Paid Submissions,” several engines offer this service on various terms. The service allows one to submit URLs, including database generated URLs, directly to the search engine. This can become very expensive if there are many items in the database.

Category Visibility

Advanced systems can also pull and re-publish a hierarchy of doorway index pages. This is important because most search engines will only index up to the first 100 or so links on a page. Creating a hierarchy of linked pages gently guides the robot to chunks of products that stay within the limits of the indexing robot.

A side benefit of maintaining a hierarchy of category index pages is that the category index page can be submitted to specific topics on search engines such as Yahoo. Managing this submission process manually for each category, let alone each product, is impractical. Submitting manually would involve choosing the correct category, then choosing the category pages that were appropriate to it and submitting the URL by hand. SEV products with category visibility features work by creating a master category list. The SEV vendor maintains a database with cross-references for each topic site that matches the directory site categories to the master categories. You simply map your own hierarchy to the master categories and the SEV system can automatically submit to the appropriate category on the directory sites.

Keyword Visibility

When a search engine robot comes to a site, it will first look for a special robots.txt file in the home directory. If it exists, it opens it and follows the instructions in the file concerning indexing the site. Unless a page is excluded in this file, and it is linked to from the home page, then all of the content on all of the pages will be indexed. The search engines give different weight to keywords that it finds in the body of the page compared to the headlines. And they give special attention to the description and keywords hidden in the header section of the page. So if you include keywords that are more popular or otherwise related to the content of the page, you are more likely to achieve a high ranking for the page in the search engines.

### SUMMARY OF THE INVENTION

The present invention discloses improvements to search engine visibility technology. There are multiple aspects to the present invention, which can be applied separately or as part of an integrated method and system. In a first embodiment, the present invention teaches a system for making certain database content visible to search engine crawlers. In a preferred embodiment, pages that are normally dynamically created when a user clicks through the link are systematically created as static pages which are stored on a server and visible to search engine indexing functions. The preferred embodiment includes a meta data model that abstracts content from the database and, combined with a template, automatically produces a static html (or other format) document. The new static pages are created in the materially same form and appearance as the dynamically created pages of the same content in order to comply with the many non-cloaking policies enforced by search engines, and the hierarchy or structure of information in the database is also preserved in the page creation process. In a preferred embodiment, the meta data model is not limited to any specific database format, so that virtually any database may be abstracted in this manner.

A second embodiment of the present innovations involves directory submission of Internet content. In a preferred embodiment, a master category list is maintained which is mapped onto the various existing search engine directories. Subject categories (or other information) from a given web page (such as, for example, a retail web page that sells products) are mapped onto the master category list. Once mapped onto the master category list, the given web page's information is then already prepared for submission to search engine directories according to how the master category list is mapped to the search engine directories. This allows automatic mapping of such content to all search engine directories to which the master category list is mapped, greatly increasing speed and efficiency of directory submission.

A third embodiment of the present innovations involves keyword and description management and submission. The current innovations allow the creation of keyword and/or description “families” which are arranged in a hierarchy matching the category structure of a web site or search engine directory. Each node of the keyword family can contain one or more keywords or descriptions of the relevant page. Each keyword or description can, for example, be linked to related keywords or descriptions, or in the case of keywords, misspelled variants, and stem variants, so that submission of a single keyword automatically includes these variants. Descriptions, families, and individual keywords can be associated with categories and products. Descriptions and keyword families deeper in the hierarchy automatically inherit all of the keywords from their parent families, plus all variants.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a standard computer system consistent with use in a preferred embodiment.

FIG. 2 shows a block diagram of a computer system consistent with use in a preferred embodiment.

FIG. 3 shows a network consistent with use in a preferred embodiment.

FIG. 4 shows a block diagram of virtual page generation.

FIG. 5 shows a block diagram of static page generation according to a preferred embodiment.

FIG. 6 shows a conceptual diagram of database design consistent with a preferred embodiment.

FIG. 7 shows a block diagram of web site filtering consistent with a preferred embodiment.

FIG. 8 shows the hierarchy of directory submission according to a preferred embodiment.

FIG. 9 shows the keyword or description submission hierarchy according to a preferred embodiment.

### DETAILED DESCRIPTION OF THE INVENTION

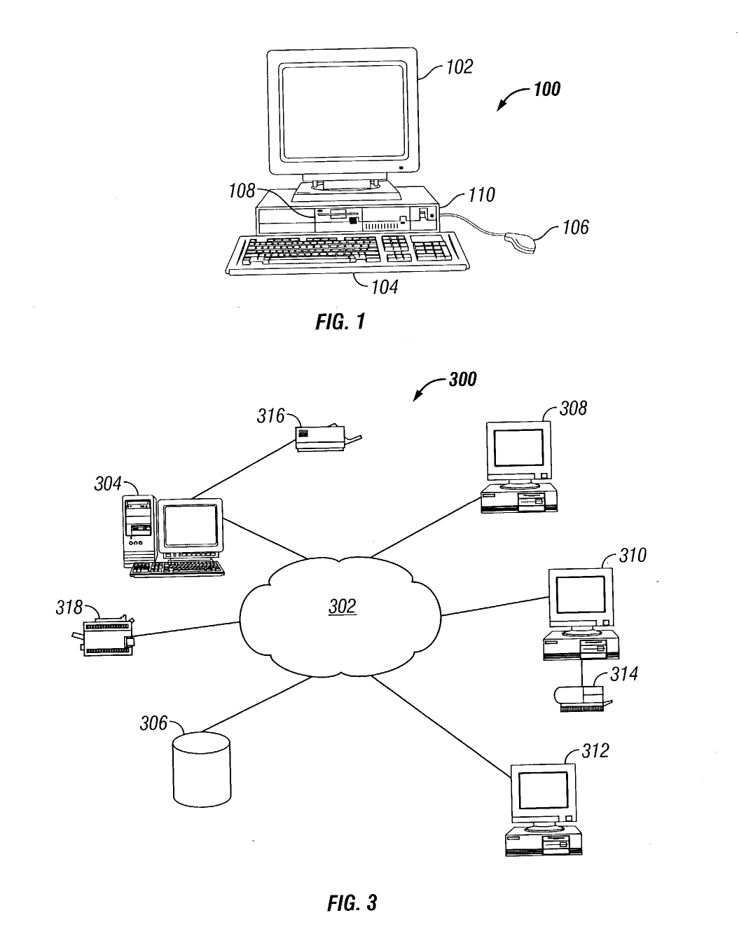

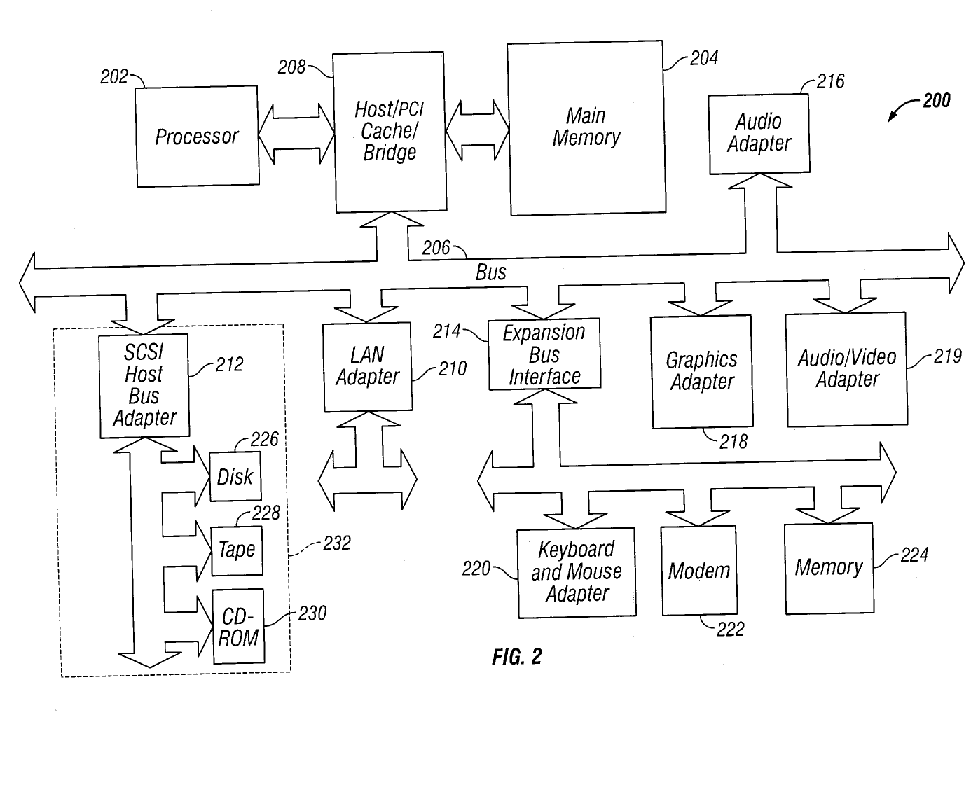

The present innovations are described in the context of a computer, or data processing system, and a computer network through which multiple computer systems communicate. With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100. With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

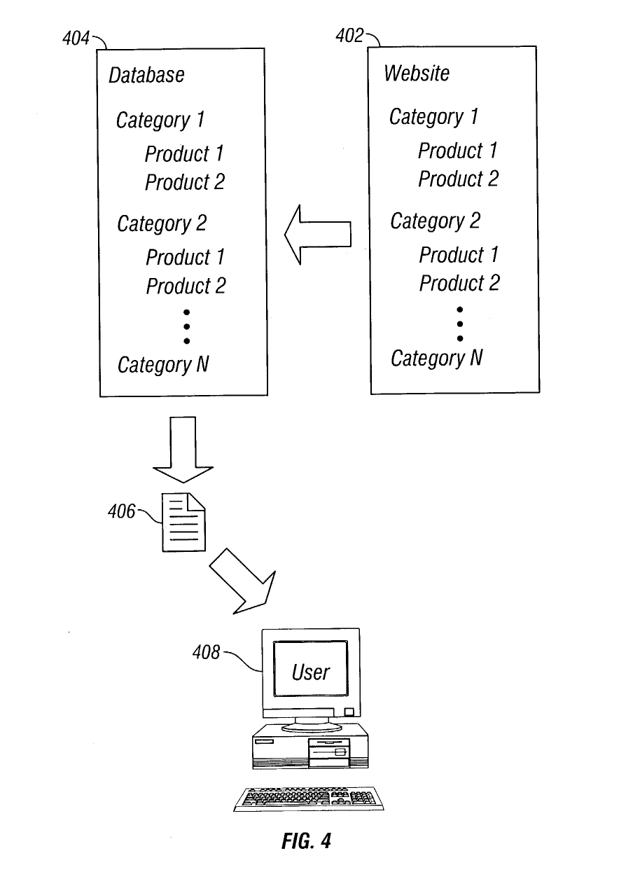

With reference now to the figures, FIG. 3 depicts a pictorial representation of a network of data processing systems in which the present invention may be implemented. Network data processing system 300 is a network of computers in which the present invention may be implemented. Network data processing system 300 contains a network 302, which is the medium used to provide communications links between various devices and computers connected together within network data processing system 300. Network 302 may include connections, such as wire, wireless communication links, or fiber optic cables.

In the depicted example, a server 304 is connected to network 302 along with storage unit 306. In addition, clients 308, 310, and 312 also are connected to network 302. These clients 308, 310, and 312 may be, for example, personal computers or network computers. In the depicted example, server 304 provides data, such as boot files, operating system images, and applications to clients 308-312. Clients 308, 310, and 312 are clients to server 304. Network data processing system 300 includes printers 314, 316, and 318, and may also include additional servers, clients, and other devices not shown.

In the depicted example, network data processing system 300 is the Internet with network 302 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 3 is intended as an example, and not as an architectural limitation for the present invention.

Though the following descriptions make reference to particular file types and formats, such as html documents, other file types are of course practicable with the present innovations.

For example, other types of Internet documents such as asp or jsp can be generated instead of html documents. Alternately, for example, the invention may generate .php, cgi, .xml, Cold Fusion, or Perle pages, or any other file format which may be invented in the future. The particular file format is not limiting to the ideas of the present innovations.

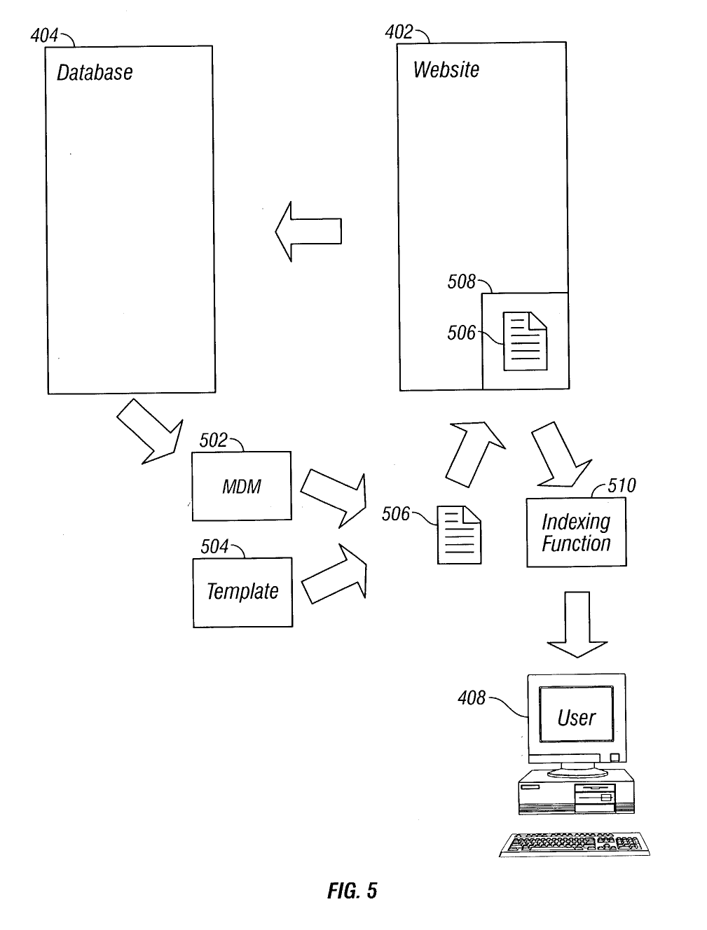

In many Internet web sites, not all pages that are viewable to a user with a browser are static pages. Some pages exist as virtual pages which are generated on-the-fly at the time a browser activates a hyperlink associated with the virtual page. FIG. 4 shows an example of virtual page generation. A web site 402 may include a list of categories and products to which a web browser can link. The list is typically arranged into a nested hierarchy. For example, retail web sites might include a list of products for sale, with links to categories of products which are further subdivided into links to individual products themselves. However, the links to the products do not go to an actual existing html document on a server. Instead, the information about the various categories and products are contained in a database 404 which supports the web site. The database can contain other information as well, for example product data such as price, quantity, availability, etc. When an Internet user 408 clicks on the link to a particular product or item to view, an algorithm collects data related to the given product from the database 404 and composes a virtual web page 406. The virtual web page 406 is an html document generated at the time the user activates the related hyperlink. The virtual web page 406 does not exist as an html document prior to activation of the related hyperlink. The page is sent to the user's browser, and the creation of the page is transparent to the typical user, who views the page on a standard browser as any other Internet hyperlink.

While the accompanying descriptions may present examples of product pages, any tipe of dynamically generated pages may be made visible using the present innovations. Additional examples include financial instruments, recipes, library materials or catalogs, research papers, etc. As discussed above, search engine indexing functions are unable to include virtual web pages as they index content on the Internet. This means virtual pages such as those on web site 402 are not indexed and therefore not included in searches performed by normal search engines. One embodiment of the present innovations provides a means to automatically and systematically create static versions of the normally virtual web pages. The static versions of the virtual pages are generated once by a computer program and stored on a server such as the server which hosts web site 402.

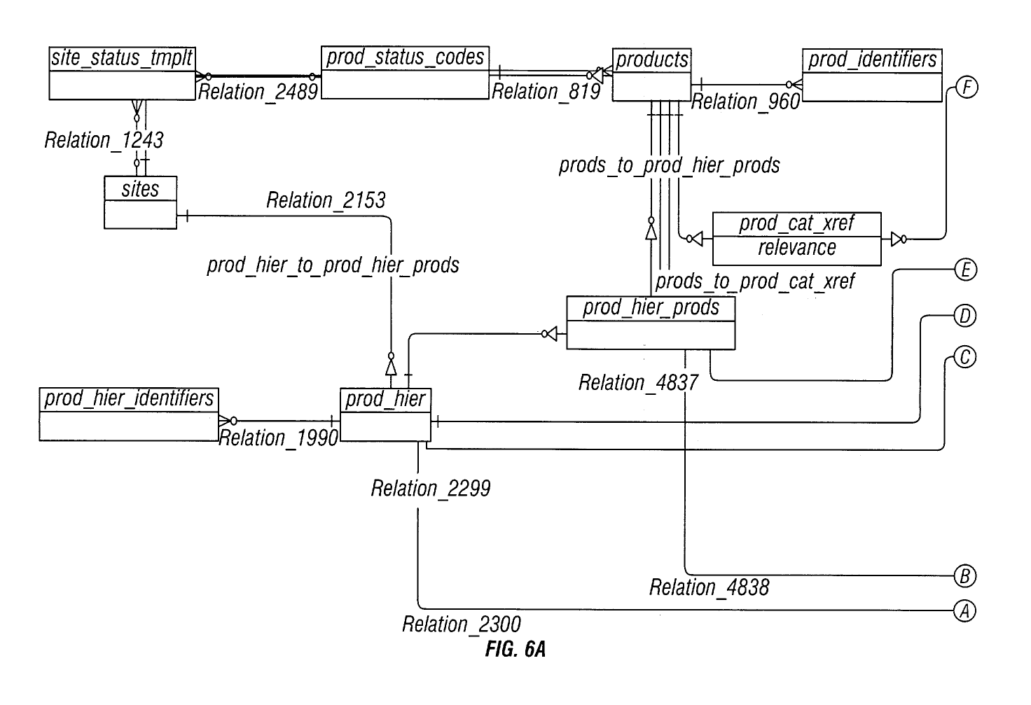

FIG. 5 shows an example implementation of a preferred embodiment. Website 402 has a nested hierarchy of links, the content for which is stored not as static html documents but as content in database 404, as described above. In the first phase of practicing the present invention, a computer program or algorithm, for example, reads the content of the virtual pages from database 404 to generate static html documents 506. The static documents 506 are generated using a meta data model 502 and a template 504.

The meta data model 502 comprises the computer program or algorithm that draws data from database 404. The template 504 is applied to the data such that the data is arranged into the same format and appearance as would be found in virtual html document 406. Once generated, static html document 506 is preferably stored on a server with web site 402 so that when a search engine indexing function 510 scans web site 402 to index its content, it finds static page 506 instead of merely a link to virtual page 406. Hence, instead of being unable to index the content now associated with both virtual page 406 and static page 506, the search engine indexing function 510 sees a normal static html document, the content of which is easily indexed and thereby included in searches performed by that search engine by a user 408.

The present innovations include the ability to mirror the form and content of the data hierarchy used in website 402 and database 404. Once the content and tags of database are “mapped” to the meta data model, the model is able to faithfully reproduce the form and content of the virtual pages on web site 402 as well as the hierarchical structure of the data. This means the search engine indexing function will see static pages which are identical to the virtual pages generated when a user normally activates the links on web site 402.

The function of the meta data model 502 is such that databases of various formats may be mapped to it, allowing the single meta data model to work with any database format. Once the content of web site 402 or database 404 is mapped to model 502, the model 502 effectively abstracts the contents. The abstracted data from model 502 is combined with template 504 to generate a static html document. Template 504 is unique to each web site 402 and includes the necessary information required to make the data from database 404 (obtained by the meta data model 502) look like the virtual pages normally generated by web site 402. Similarly, the meta data model 502 retains the hierarchical structure of data in database 404 so that the static html documents 506 which are generated are also in that hierarchy. Thus, this embodiment of the present innovations generates static html documents in the same structure and with the same appearance as the virtual pages normally viewed by a browser.

In a preferred embodiment, the meta data model associates product ID data from the target database and puts it into a common format used by the meta data model. Once the particular tags used to identify product data on the target database are mapped to the meta data model (which is accomplished by a configuration process), the meta data model is able to draw product data from the database and, combined with the template, use the data in the proper location to form a document identical to the virtual document normally generated by the web site. This allows a single meta data model to be a common platform for any database, regardless of the format used by the database.

The static pages generated by the template and meta data model are preferably stored in a directory associated with and local to the other content on the web site 402. When a search indexing function crawls the content of that web site, it would normally (in non-innovative systems) see the link to virtual page 406 which cannot be crawled. With the present innovations, the crawler is directed to the directory 508 containing the static pages 506, which can be crawled and indexed by the search engine indexing function.

The meta data model is preferably able to deal with various product ID schemes used by databases, including those using multiple keyword identifiers for product IDs. The meta data model accomplishes its task using tag substitution, and structured query language (SQL) inquiries made to the relevant database entry to retrieve the information needed to compose the static web page 506. Such data preferably includes all product data which is normally used to generate the virtual web page 406. Using the current invention, a complete product hierarchy can be generated after the development of only 6 SQL (Structured Query Language) statements. In a preferred embodiment, these can include:

1. Initial Product List (All Products)

2. Product Details (Specific Product)

3. Initial Hier List (Root Hierarchy Nodes)

4. Hier List (Sub-nodes of a Specific Node)

5. Hierarchy Details (Specific Node)

6. Hier Products (Products in a Specific Node)

Each of these statements may include the above mentioned tags as represented in brackets in the example of a ‘product details’ SQL statement presented below:

SELECT product.*FROM product WHERE product_id={SDProductIdentifiers.PRoduct_ID}

Data items are defined by pointing to column names on one of the above statements, or by defining an additional SQL statement such as the one below:

SELECT thumbnail_pic FROM thumbnails WHERE thumbnails.product_id={SDProductIdentifiers.product_id}

The above statement may return a single row or multiple rows. Other information might include items such as the colors an item is available in, or the sizes available for the incident product.

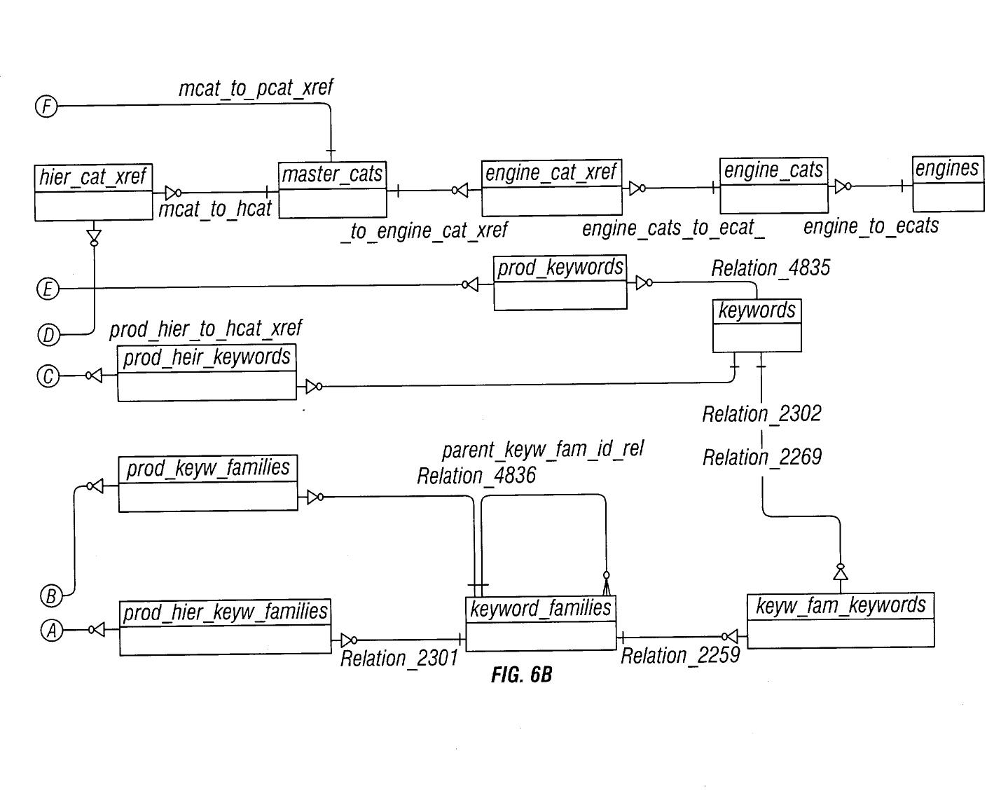

FIG. 6 shows a conceptual model of how the present innovations are implemented in a database. This diagram is intended to provide an example overview of multiple key value meta data models plus keyword inheritance and directory mapping elements of the present innovations.

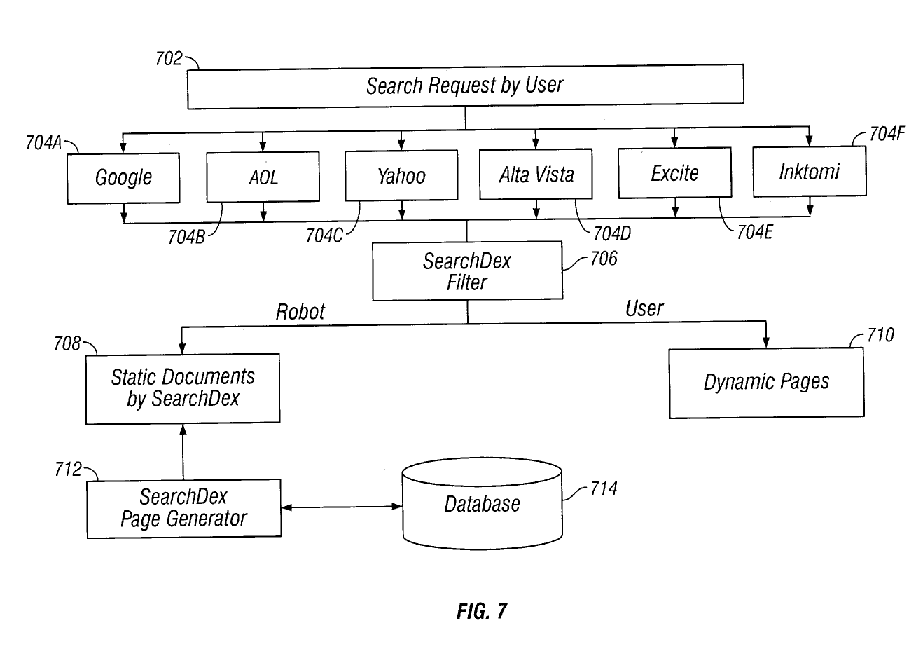

FIG. 7 shows an overview of the innovative system. A user performs a search engine request 702 on an Internet search engine such as Google™, etc. 704A-F. The search request is filtered by filter 706 which recognizes the search request as an actual user request as opposed to an inquiry by a search engine indexing function based on commercially available databases of known search engine crawler IP addresses. In the case of an actual request, the links returned to satisfy the user request 702 are virtual or dynamic pages 710 generated on the fly by an algorithm associated with the relevant web site which includes the page linked to. Dynamic pages 710 are generated from data contained in a database 714 associated with the web site.

In the case where a spider or other search engine indexing function requests the content associated with such a virtual page, the filter 706 directs the indexing function to static document 708 instead of dynamic pages 710 so that the content will be indexed by the search engine. The static documents 708 are preferably generated by the above described process using the SearchDex page generator 712. The page generator 712 uses the data from the web site database 714.

An example process flow for performing the above described filtering is shown below:

1. Check to see if the host IP address is in the list of known spiders. This is available on the Referrer object. Set a value True or False appropriately.

2. If True (i.e., a known spider), DO NOTHING, which allows the present page to be sent back to the agent (i.e., the search engine spider).

3. Only if False (i.e., not a known spider, therefore a user), do an HTTP redirect response (301 or 302).

This contrasts with prior art systems in which spiders are typically redirected, causing the content to not be indexed by the spider because most search engine spiders or indexing functions will not follow a redirected link.

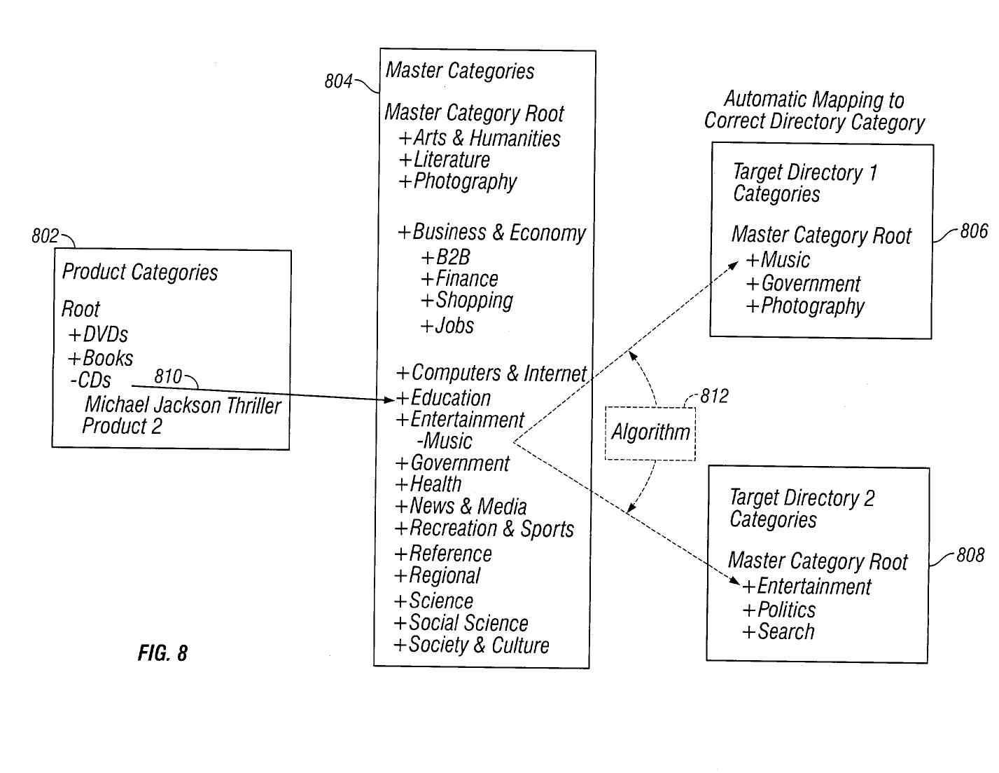

FIG. 8 shows another embodiment of the present innovations. This embodiment provides a system and method for directory submission of Internet content to search engine directories. As described above, every search engine can have a different set of terms used in its directory hierarchy. Web sites that submit their content to such directories are typically required to individually match their content to the particular terminology of each different search directory.

FIG. 8 shows the product categories 802 of an example web site, where the content of example web site is to be submitted to target directories 806, 808. The web site content 802 to be categorized is in this example a CD of Michael Jackson's “Thriller” 810. Such content 810 would need to be individually associated with the category “music” in target directory 806 and also with the category “entertainment” in target directory 808. In the case where other target directories (not shown) are also desired, the content 810 would also have to be individually associated with these other target directories.

According to the present innovations, content 810 is mapped onto the proprietary master category list 804. The master category list 804 is preferably already mapped to various search engine directories, including target directories 1 and 2 806, 808. After the content 810 is submitted to the master category list 804, the content is automatically mapped to all search engine directories to which master category list 804 is mapped. In this example, content 810 is mapped to the subcategory “music” on the master category list 804, which has previously been mapped to both target directory 1 806 and target directory 2 808. Hence, a single submission of content 810 provides accurate submission to a plurality of search engine databases.

In a preferred embodiment, an algorithm 812 associated with the master category list 804 performs automatic submission of content 810 to multiple target directories after content 810 has been mapped to master category list 804.

A common problem with directory mapping is that not all categories map cleanly to a corresponding category in a target directory. For example, if the target directory category is called ‘Entertainment,’ but the incident category is called ‘Music,’ there is some association but not a clearly direct one-to-one mapping between the two categories. The present innovations allow for a ‘relevance’ ranking of each mapping between 0 and 100.0 represents no real relevance, while 100 represents a direct one-to-one mapping. Maintaining relevance in the mappings allows a client to determine how aggressively they map into the target database. Typically, to avoid mapping into irrelevant categories in the target directory, a client would choose to submit only to categories with a relevancy above 50%, for example. Of course any choice could be made depending on the desired implementation.

In the present invention, relevance is recorded for the categories mapped from the client's hierarchy to the Master Category list as well as mapping from the Master Category List to the search engine directories. this allows for the degradation of relevancy effects that can occur after multiple mappings. For example, in a scenario in which the category mappings were as follows:

Thriller→(R1=90)→Music→(R2=80)→Entertainment

The compound relevancy of the mapping from Thriller to Entertainment is ((R1/100)*(R2/100))*100, or in this case 72. Since 72 is above the example threshold of 50, the mapping to ‘Entertainment’ would be considered relevant.

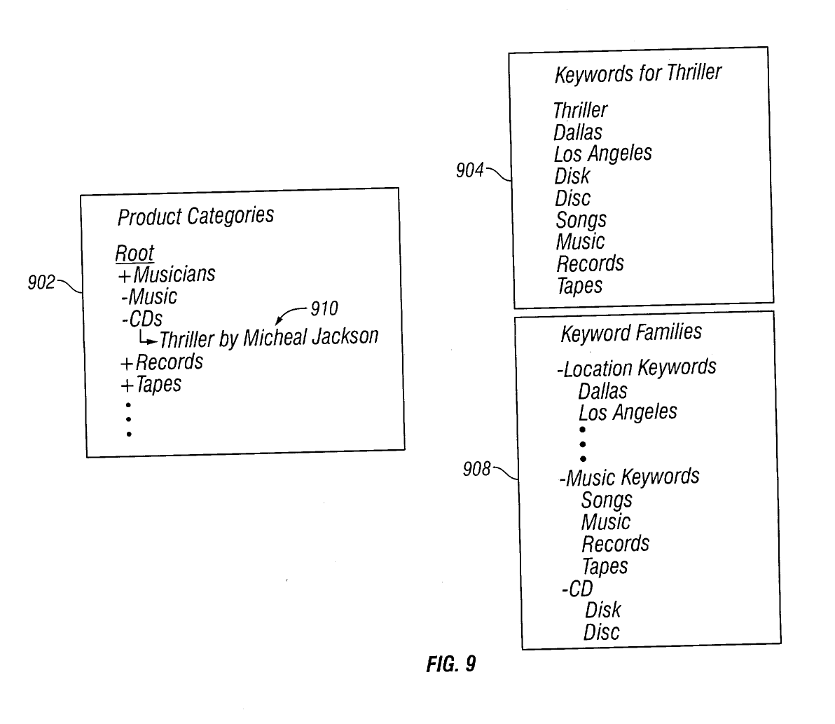

FIG. 9 shows another embodiment of the present innovations. In this embodiment, key words are generated for a particular product 910 according to associated keyword categories. A first set of keywords includes those found by a search engine indexing function which crawls the page to describe the product 910 in a search engine keyword directory (not shown) entered into database tables. These keywords are selected by the crawler or indexing function because of their location and frequency in the particular product web page. They can also be intentionally placed in tags within the source code of the page, viewable only to search engines or by viewing the source of the page. Different search engines rank keywords differently according to their individual algorithm. In this example, the keywords selected by the crawler includes the word “Thriller.”

Additionally, keywords are also generated for that product page by referring to the keyword categories and families. In this example, the product page is categorized under “CDs” which is under “Music” in the product categories 902. The product will inherit all keywords in the “CD” keyword family as well as all keywords in the music keyword family. The product also, in this example, inherits the related category of location. Hence, the final list of keywords would include Thriller, Dallas, Los Angeles, Disk, Disc, Songs, Music, Records, and Tapes. This list is shown in the Keywords list for Thriller 904.

According to a preferred embodiment of the present innovations, the product 910 is also automatically associated with the keywords of its root category according to the existing keyword families, which comprise parent categories and child categories. These added keywords become part of the set of keywords 904 associated with product 910. Note that the added keywords themselves come from a plurality of nested categories within the keyword families 908, including Location keywords, Music keywords, and CD keywords. Other categories can also be associated with any given content 910.

The keyword families are created in a hierarchy. Each node of the keyword family hierarchy can contain one or more keywords, and each keyword can be associated with related keywords, misspelled variants, and stem variants. Families and individual keywords are preferably associated with categories and products such as category 902 and product 910. Keyword categories can contain keywords and subcategories. For example, the “CD” keywords include songs and music, and can also include a subcategory called “Music” which itself would include more keywords one level down in the hierarchy. Lower level groups are referred to as child families, and higher level groups are referred to as parent or ancestor families. Child families preferably inherit all of the keywords from their parent families, plus all variants. Child family keywords take precedence over ancestor keywords. The inheritance of keywords is preferably automatic, performed by first retrieving and expanding the keyword families at the product's incident category, combining them with the individual keyword defined at the incident category, then performing the same tasks on the incident category's parent category, etc., up to the root category. Descriptions are inherited in the same manner but are paragraphs of descriptive text that are resolved using the above mechanism but then displayed as visible text on the product or item page itself. Keywords, keyword families, and descriptions are stored in the same meta data tables used to store the product hierarchy from the back-end system. Once the set of keywords or descriptions are associated with the page, they may be efficiently submitted to search engine keyword indexing functions.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A system for generating documents from files in a database, comprising:
a database having files, each of the files including data identified by a first set of tags;
a first algorithm which accesses the data from the database and substitutes a second set of tags for the first set of tags;
a second algorithm which arranges the data into a document according to the second set of tags.

2. The system of claim 1, wherein the document is an html document.

3. The system of claim 1, wherein the data is not accessible to search engine index functions until it is arranged into the document according to the second set of tags.

4. The system of claim 1, wherein the first algorithm is a meta data model and the second algorithm is a template.

5. A method of using a database, comprising the steps of:
accessing the files in the database, wherein the files include a first plurality of tags which identify data in the files and wherein the data in the files are capable of being arranged into a first set of documents, the first set of documents comprising a hierarchy;
substituting a second plurality of tags for the first plurality of tags;
generating a second set of documents from the data wherein the data in the second set of documents is arranged the same way as in the first set of documents.

6. The method of claim 5, wherein the second set of documents comprises the same hierarchy as the first set of documents.

7. The method of claim 5, wherein the first set of documents are virtual documents and the second set of documents are static documents.

8. The method of claim 7, wherein the second set of documents are hypertext markup language documents.

9. A method for generating documents from the contents of a database, wherein the database includes hierarchical information, comprising the steps of:
identifying data in the database, the data being associated with a first document and identified by a first plurality of tags;
accessing the data;
substituting a second plurality of tags for the first plurality of tags;
generating a second document from the data wherein the second document includes the same content as the first document.

10. The method of claim 9, wherein the content of the second document is arranged as is the content of the first document.

11. The method of claim 9, wherein the first document is a virtual document linked on a web page that is generated from the associated data in the database whenever a user activates the hyperlink to the first document with a browser.

12. The method of 11, wherein the second document is a static document.

13. A method of mapping Internet content to search engine directories, comprising the steps of:
mapping a master category list to a plurality of search engine directories;
mapping content from an Internet site to the master category list;
submitting the content to the plurality of search engine directories.

14. The method of claim 13, wherein each category of the master category list is associated with at least one category in each search engine directory.

15. The method of claim 13, wherein the content is automatically submitted to the plurality of search engine directories by a compute program.

16. The method of claim 13, wherein the association between a category in the master category list and a category of the search engine directories is assigned a relevancy value.

17. The method of claim 16, wherein the relevancy value is higher between a category in the master category list and a category of the search engine directories if the category in the master category list is similar to the category of the search engine directories; and
wherein the relevancy value is lower between a category in the master category list and a category of the search engine directories if the category in the master category list is dissimilar to the category of the search engine directories.

18. A method of mapping Internet content to search engine directories, comprising the steps of:
mapping a master category list to a plurality of search engine directories, wherein each category of the master category list is associated with at least one category in each search engine directory;
associating a web page with at least one category in the master category list;
submitting the web page to the plurality of search engine directories, wherein the web page is entered into all search engine categories associated with the at least one category in the master category list.

19. The method of claim 18, wherein the once the web page is associated with the at least one category in the master category list, the web page is automatically submitted to the plurality of search engine directories by a computer program.

20. The method of claim 18, wherein the association between a category of the master category list and a category of the search engine categories is assigned a relevancy value.

21. The method of claim 20, wherein the relevancy value is higher between the category in the master category list and the category of the search engine categories if the category in the master category list is similar to the category of the search engine categories; and
wherein the relevancy value is lower between the category in the master category list and the category of the search engine categories if the category in the master category list is dissimilar to the category of the search engine categories.

22. A method of associating keywords with web pages, comprising the steps of:
generating groups of keywords, each keyword in a group being associated with other keywords in that group;
nesting the groups of keywords in a hierarchy such that keywords in a first group are associated with keywords in a second group, wherein the second group includes the first group;
associating at least one group of keywords with a web page.

23. The method of claim 22, wherein the keywords associated with the web page are automatically submitted to search engine keyword directories by a computer program.

24. The method of claim 22, wherein the keywords in the second group are not associated with the keywords in the first group.

25. The method of claim 22, wherein the keyword groups are arranged in a nested hierarchy, with keywords in subgroups of the hierarchy being associated with keywords in groups in which they are nested, but wherein the keywords in a given group are not necessarily associated with the keywords of subgroups nested in the given group.

26. A method of associating descriptions with web pages, comprising the steps of:
generating groups of descriptions, each description in a group being associated with other descriptions in that group;
nesting the groups of descriptions in a hierarchy such that descriptions in a first group are associated with descriptions in a second group, wherein the second group includes the first group;
associating at least one group of descriptions with a web page.

27. The method of claim 26, wherein the descriptions associated with the web page are automatically submitted to search engine description directories by a computer program.

28. The method of claim 26, wherein the descriptions in the second group are not associated with the descriptions in the first group.

29. The method of claim 26, wherein the description groups are arranged in a nested hierarchy, with descriptions in subgroups of the hierarchy being associated with descriptions in groups in which they are nested, but wherein the descriptions in a given group are not necessarily associated with the descriptions of subgroups nested in the given group.
